(19) United States
(12) Patent Application Publication
(10) Pub. No.: US 2012/0294313 A1
(43) Pub. Date: Nov. 22, 2012

(54) NETWORK RELAY DEVICE AND DIAGNOSTIC METHOD

(75) Inventor: Kenji Mitsuhashi, Kawasaki (JP)

(73) Assignee: FUJITSU LIMITED, Kawasaki-shi (JP)

(21) Appl. No.: 13/562,582

(22) Filed: Jul. 31, 2012

Related U.S. Application Data
(63) Continuation of application No. PCT/JP2010/051796, filed on Feb. 8, 2010.

(51) Int. Cl. H04L 12/56

(52) U.S. Cl. 370/401

(57) ABSTRACT

In a network relay device, a routing table stores information of a transfer destination of a packet. A forwarding unit determines the transfer destination of a packet based on information of the routing table. A switch unit switches output destinations of the packet to the forwarding unit based on the determination of a transfer destination by the forwarding unit. A diagnostic packet generator generates a diagnostic packet that circulates through an active path within the device based on the information of the routing table. A diagnostic packet transmitter sends out a diagnostic packet generated by the diagnostic packet generator to the forwarding unit via the switch unit.

### CROSS-REFERENCE TO RELATED APPLICATION

This application is a continuation application of International Application PCT/JP2010/051796 filed on Feb. 8, 2010 and designated the U.S., the entire contents of which are incorporated herein by reference.

### FIELD

The embodiments discussed herein are related to a network relay device and a diagnostic method that diagnose a path of a packet within the device.

### BACKGROUND

In the IP (Internet Protocol) network, the mainstream of a high-end router that enables high-speed and large-capacity packet forwarding is hardware processing of packets. Further, in order to realize expandability of processing performance, it is possible to increase/decrease the number of forwarding processors. In a router having such characteristics, as a search system of a forwarding destination of a packet, for example, a two-stage search system that searches for a forwarding destination in the Ingress direction and in the Egress direction, respectively, is adopted.

FIG. 20 is a block diagram of an IP router of the two-stage search system. As illustrated in FIG. 20, the IP router has a controller 101, forwarding processors 102 and 103 the number of which may be increased/decreased, a switch 104, and ports 105a to 105c and 106a to 106c. The forwarding processor 102 has an I (Ingress)-side module 102a and an E (Egress)-side module 102b and the forwarding processor 103 has an I-side module 103a and an E-side module 103b.

The I-side modules 102a and 103a determine the E-side modules 102b and 103b, which are transfer destinations of IP packets received at the ports 105a to 105c and 106a to 106c. The switch 104 outputs the packets, the output destinations of which are determined to be the E-side modules 102b and 103b by the I-side modules 102a and 103a, to the E-side modules 102b and 103b determined in advance. The E-side modules 102b and 103b determine the ports 105a to 105c and 106a to 106c, which are transfer destinations of IP packets.

The controller 101 has a routing table, though not illustrated in FIG. 20, and controls the transfer destinations of the IP packets of the I-side modules 102a and 103a and the E-side modules 102b and 103b. That is, the I-side modules 102a and 103a and the E-side modules 102b and 103b determine the transfer destinations of the IP packets by the control of the controller 101.

For example, an IP packet received at the port 105a is determined to be transferred to the E-side module 102b by the I-side module 102a. The IP packet the transfer destination of which is determined is output to the E-side module 102b by the switch 104. The E-side module 102b outputs the packet transferred from the I-side module 102a to the port 105b. Further, the IP packet received at the port 106a is determined to be transferred to the E-side module 102b by the I-side module 103a. The IP packet the transfer destination of which is determined is output to the E-side module 102b by the switch 104. The E-side module 102b outputs the packet transferred from the I-side module 103a to the port 105c. In this manner, the IP router adopting the two-stage search system outputs received IP packets from the ports 105a to 105c and 106a to 106c determined in advance.

The high-end IP router is capable of high-speed and large-capacity processing, and therefore, usually disposed in the center part of the IP network and it is preferable for an unexpected downtime by a hardware failure to be as short as possible. Because of this, the high-end IP router is provided with a failure detecting function in a single hardware body, an interface unit connecting devices, etc., and thereby, a failure is monitored in a system running (online) state.

However, in general, for a high-end IP router, a general-purpose device available in the market is frequently used and there is a limit to enhancement of the device failure detecting function. Because of this, in a high-end IP router, for the purpose of complementing the function to detect a failure, a diagnostic packet is made to circulate in the device in the online state and thus its normality is confirmed.

Conventionally, a packet signal routing device incorporating a self-diagnostic method is proposed (for example, see Japanese Laid-Open Patent Publication No. 11-331259).

Further, a network system is proposed, in which a program for monitoring and controlling network system resources is circulated as a circulation program through all the devices on the network and the result of execution of the program in each device is taken in the circulation program (for example, see Japanese Laid-Open Patent Publication No. 10-313337).

However, a conventional network relay device used to have such a problem that it is not possible to diagnose the path through which a user packet passes actually.

For example, the controller 101 of FIG. 20 sends out a diagnostic packet to the forwarding processor 102 via the switch 104 and receives the diagnostic packet from the forwarding processor 102. Thereby, it is possible for the controller 101 to diagnose, for example, the devices and interface between devices within the forwarding processor 102 based on whether or not the diagnostic packet that has been sent out returns.

However, as described above, the controller 101 simply sends out a diagnostic packet to the forwarding processor 102 and receives the diagnostic packet therefrom, and therefore, it is not possible to diagnose, for example, the path of a user packet via the forwarding processor 103, the switch 104, and the forwarding processor 102 or the path of a user packet via the forwarding processor 102, the switch 104, and the forwarding processor 102. Because of this, it is not possible for the controller 101 to diagnose data within a memory or a software error for determining the path of a user packet within, for example, the forwarding processors 102 and 103.

### SUMMARY

According to an embodiment, a network relay device that diagnoses a path of a packet within the device has a routing table storing information of a transfer destination of the packet, a forwarding unit configured to determine a transfer destination of the packet based on the information of the routing table, a switch unit configured to switch output destinations of the packet to the forwarding unit based on the determination of the transfer destination by the forwarding unit, a diagnostic packet generator configured to generate a diagnostic packet that circulates through an active path within the device based on the information of the routing table, and a diagnostic packet transmitter configured to send out the diagnostic packet generated by the diagnostic packet generator to the forwarding unit via the switch unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a network relay device according to a first embodiment;

FIG. 2 is a block diagram of a network relay device according to a second embodiment;

FIG. 3 explains an active path of a user packet;

FIG. 4 explains an online diagnosis of a diagnostic path;

FIG. 5 is a block diagram of an SCM;

FIG. 6 illustrates a routing table;

FIG. 7 illustrates a diagnostic packet generation table;

FIG. 8 explains generation of a diagnostic packet;

FIG. 9 explains a diagnostic packet transmitter;

FIG. 10 explains loopback of a diagnostic packet of an LTM;

FIG. 11 is a diagram of part 1 for explaining a diagnosis example of an active path;

FIG. 12 is a diagram of part 2 for explaining the diagnosis example of the active path;

FIG. 13 is a flowchart illustrating diagnosis processing of an active path;

FIG. 14 explains a load of a network relay device by a diagnostic packet;

FIG. 15 is a diagram of part 1 for explaining a diagnostic path for identifying a failed portion of a network relay device;

FIG. 16 is a diagram of part 2 for explaining the diagnostic path for identifying a failed portion of the network relay device;

FIG. 17 is a diagram of part 3 for explaining the diagnostic path for identifying a failed portion of the network relay device;

FIG. 18 is a diagram of part 4 for explaining the diagnostic path for identifying a failed portion of the network relay device;

FIG. 19 is a flowchart illustrating processing to identify a failed portion; and

FIG. 20 is a block diagram of an IP router adopting a two-stage search system.

### DESCRIPTION OF EMBODIMENTS

Several embodiments will be described below with reference to the accompanying drawings, wherein like reference numerals refer to like elements throughout.

A first embodiment is described below with reference to the accompanying drawings.

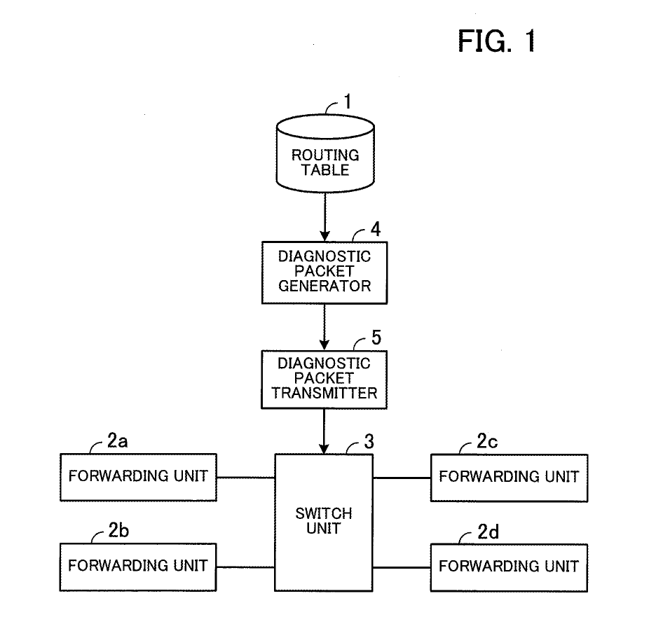

FIG. 1 is a block diagram of a network relay device according to the first embodiment. As illustrated in FIG. 1, the network relay device has a routing table 1, forwarding units 2a to 2d, a switch unit 3, a diagnostic packet generator 4, and a diagnostic packet transmitter 5.

The routing table 1 stores information of transfer destinations of packets (user packets).

The forwarding units 2a to 2d are connected to the switch unit 3. The forwarding units 2a to 2d determine transfer destinations of packets based on information of the routing table 1.

The switch unit 3 switches output destinations of packets to the forwarding units 2a to 2d based on the determination of transfer destinations by the forwarding units 2a to 2d.

The diagnostic packet generator 4 generates a diagnostic packet that circulates through an active path within the device based on information of the routing table 1. An active path generally refers to an effective network path for a user packet to reach an address prefix thereof, but, here, it refers to a path within the network relay device through which a user packet passes to reach an address prefix. For example, when a user packet passes through from the forwarding unit 2a to the forwarding unit 2b via the switch unit 3, this path is called an active path.

The diagnostic packet transmitter 5 sends out a diagnostic packet generated by the diagnostic packet generator 4 to the forwarding units 2a to 2d via the switch unit 3.

Here, a diagnostic packet is generated so as to circulate through an active path based on the routing table 1 storing information of transfer destinations of user packets. Because of this, the path of a diagnostic packet is determined by the forwarding units 2a to 2d in the same manner as that of the path through which a user packet passes. Consequently, by a determiner, not illustrated in FIG. 1, receiving a diagnostic packet having circulated within the device, it is made possible to diagnose the path through which a user packet passes within the device.

As described above, the network relay device generates a diagnostic packet that circulates through an active path within the device based on the routing table 1 and causes the diagnostic packet to circulate within the device. Due to this, it is possible to diagnose the path through which the user packet passes.

Next, a second embodiment will be described in detail below with reference to the accompanying drawings, wherein like reference numerals refer to like elements throughout.

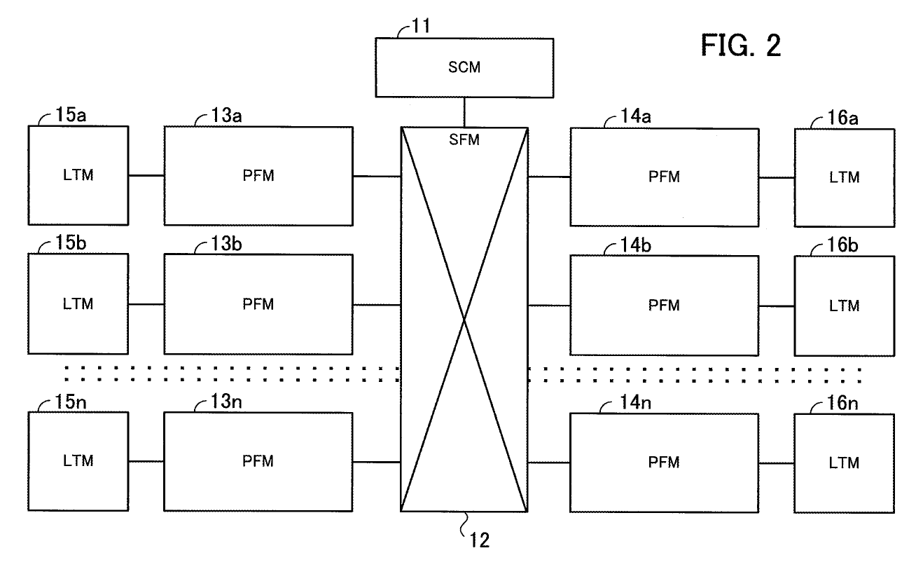

FIG. 2 is a block diagram of a network relay device according to the second embodiment. As illustrated in FIG. 2, the network relay device has an SCM (System Control Module) 11, an SFM (Switch Fabric Module) 12, PFMs (Packet Forwarding Modules) 13a to 13n and 14a to 14n, and LTMs (Line Terminal Modules) 15a to 15n and 16a to 16n. The network relay device is, for example, a high-end IP router.

The SCM 11 is a module configured to perform system control and management of the network relay device, routing protocol termination processing, etc. Further, the SCM 11 performs generation of a diagnostic packet, transmission and reception, confirmation of normality, etc. The SCM 11 has a routing table, though not illustrated in FIG. 2, and controls transfer destinations of packets of the PFMs 13a to 13n and 14a to 14n.

The SFM 12 is a module configured to perform packet switching between the PFMs 13a to 13n and 14a to 14n. The SFM 12 connects the PFMs 13a to 13n and 14a to 14n accommodating a packet input interface and a packet output interface by the cross bar switch system.

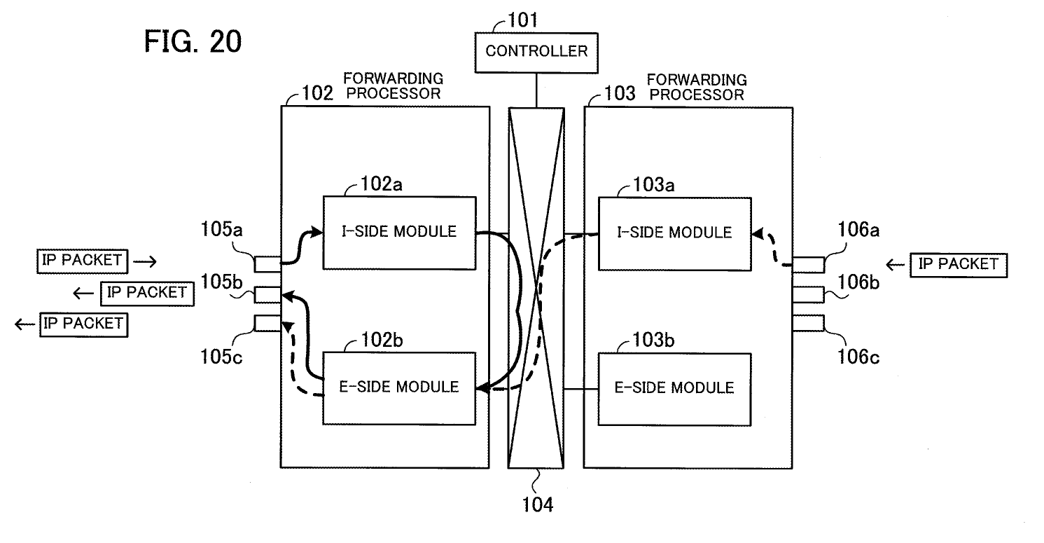

The PFMs 13a to 13n and 14a to 14n are modules configured to perform protocol termination processing etc. of Layer 2 and Layer 3. As explained in FIG. 20, each of the PFMs 13a to 13n and 14a to 14n has the I-side module and the E-side module and searches for a forwarding destination of a packet in the Ingress direction and in the Egress direction based on the control of the SCM 11 (two-stage search system).

The LTMs 15a to 15n and 16a to 16n are modules configured to perform protocol termination processing of Layer 1 and Layer 2 processing. The LTMs 15a to 15n and 16a to 16n perform confirmation of normality of a packet received form the line, removal of the header and tailer of Layer 1, processing to remove the tailer of Layer 2, etc. Further, the LTMs 15a to 15n and 16a to 16n perform attachment of a tailer of Layer 2 of a packet to be output to the line, processing to attach a header and a tailer of Layer 1, etc.

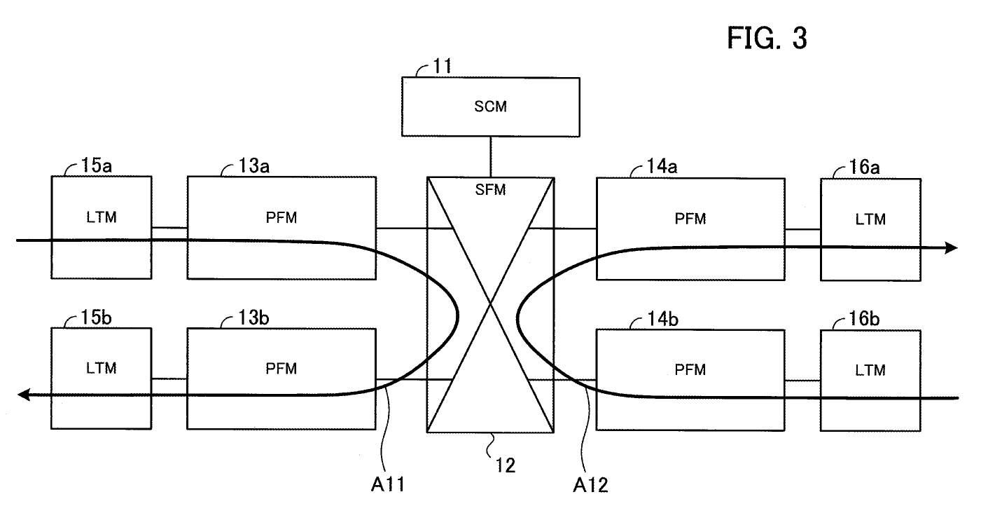

FIG. 3 explains an active path of a user packet. In the network relay device of FIG. 3, the same symbols are attached to the same components as those of FIG. 2 and their explanation is omitted. In the network relay device of FIG. 3, the four PFMs 13a, 13b, 14a, and 14b and the four LTMs 15a, 15b, 16a, and 16b are illustrated.

Arrows A11 and A12 illustrated in FIG. 3 indicate active paths through which a user packet passes. For example, as indicated by the arrow A11, a user packet input to the LTM 15a is determined to be transferred to the PFM 13b by the PFM 13a and output to the SFM 12. The SFM 12 outputs the input user packet to the PFM 13b based on the determination by the PFM 13a. The PFM 13b outputs the user packet input from the SFM 12 to the LTM 15b and the LTM 15b outputs the user packet to a predetermined address prefix.

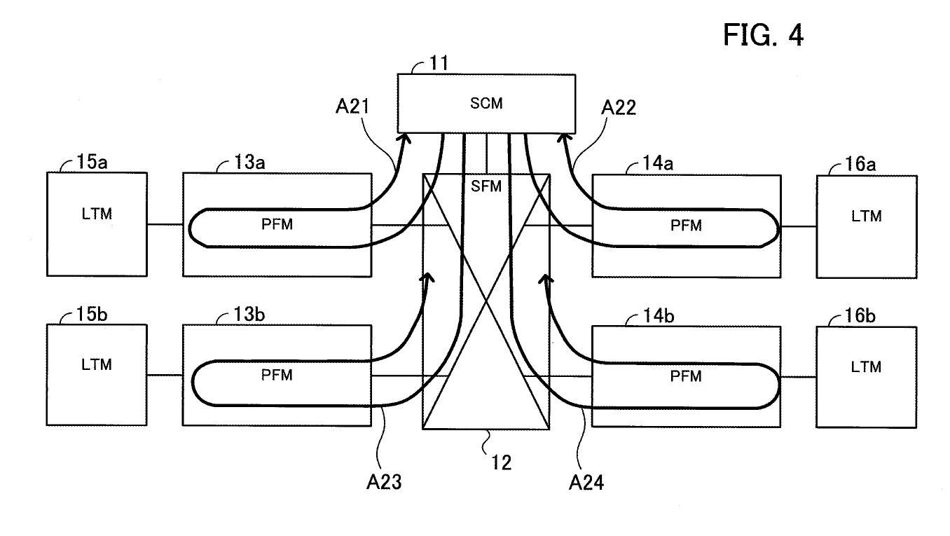

FIG. 4 explains an online diagnosis of a diagnostic path. In FIG. 4, the same symbols are attached to the same components as those of FIG. 3 and their explanation is omitted.

Conventionally, the SCM 11 used to perform an online diagnosis by transmitting a diagnostic packet from itself to the PFMs 13a to 13n and 14a to 14n and causing the diagnostic packet to return to itself again. For example, the SCM 11 used to perform an online diagnosis by transmitting a diagnostic packet to the PFMs 13a to 13n and 14a to 14n and causing the diagnostic packet to return to itself again as indicated by arrows A21 to A24 in FIG. 4.

Because of that, by the online diagnosis of FIG. 4, it is not possible to diagnose the active paths through which a user packet actually passes through the PFMs 13a, 13b, 14a, and 14b as indicated by the arrows A11 and A12 of FIG. 3. For example, in FIG. 4, it is not possible to diagnose the active path running from the PFM 13a through the PFM 13b via the SFM 12.

Further, by the online diagnosis of FIG. 4, it is not possible to diagnose the active path running and looping back through the PFM 13a, 13b, 14a, or 14b itself. For example, in FIG. 4, it is not possible to diagnose the loopback active path, such as the LTM 15a-PFM 13a-SFM 12-PFM 13a-LTM 15a.

Consequently, by the online diagnosis of FIG. 4, it is possible to diagnose the devices and the interfaces between devices within each of the PFMs 13a, 13b, 14a, and 14b, but, not to diagnose the data within the memory to determine the routing of a user packet, a software error, or the packet switching of the SFM 12. Because of that, there occurs a case where it is not possible to detect an anomalous state where a specific flow has stuck.

Consequently, the SCM 11 generates a diagnostic packet that circulates through an active path of a user packet based on the routing table. For example, in FIG. 4, the SCM 11 generates a diagnostic packet that circulates through the SCM 11-SFM 12-PFM 13a-LTM 15a-PFM 13a-SFM 12-PFM 13b-LTM 15b-PFM 13b-SFM 12-SCM 11. Due to this, it is possible for the SCM 11 to diagnose (to detect a failure of), for example, the active path of the user packet by the arrow A11 of FIG. 3 by the presence/absence of reception of the diagnostic packet the SCM 11 has sent out into the device, the change in the payload data of the received diagnostic packet, etc.

As a method for causing a diagnostic packet that circulates within the network relay device to return to the SCM 11 again, Time Exceeded is used. For example, the SCM 11 transmits ICPM Time Exceeded Message to the transmission source in a packet in which TTL (Time To Live) has reached ‘0’. Because of that, the PFMs 13a, 13b, 14a, and 14b transmit a packet in which TTL=0 to the SCM 11. Then, the SCM 11 sets predetermined TTL in a diagnostic packet and utilizes the returning of the packet in which TTL=0 to the SCM 11 by the PFMs 13a, 13b, 14a, and 14b.

Specifically, the SCM 11 sets TTL so that a diagnostic packet to be generated passes through a predetermined active path. TTL of the diagnostic packet is decremented each time the diagnostic packet passes through the PFMs 13a, 13b, 14a, and 14b (each time the diagnostic packet passes through the I-side module). The PFMs 13a, 13b, 14a, and 14b transfer the diagnostic packet to the SCM 11 when TTL of the diagnostic packet has reached ‘0’. Consequently, for example, when causing the generated diagnostic packet to pass through the SCM 11-SFM 12-PFM 13a-LTM 15a-PFM 13a-SFM 12-PFM 13b-LTM 15b-PFM 13b-SFM 12-SCM 11 described above, the SCM 11 sets TTL=2

The operation to loop back the diagnostic packets received by the LTMs 15a, 15b, 16a, and 16b from the PFMs 13a, 13b, 14a, and 14b to the PFMs 13a, 13b, 14a, and 14b will be described later.

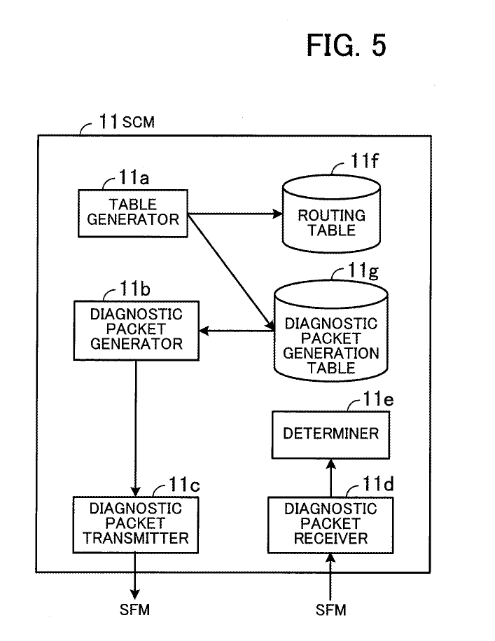

FIG. 5 is a block diagram of the SCM. As illustrate in FIG. 5, the SCM 11 has a table generator 11a, a diagnostic packet generator 11b, a diagnostic packet transmitter 11c, a diagnostic packet receiver 11d, a determiner 11e, a routing table 11f, and a diagnostic packet generation table 11g.

The table generator 11a generates the diagnostic packet generation table 11g with which the diagnostic packet generator 11b generates a diagnostic packet that circulates through an active path based on the routing table 11f.

The diagnostic packet generator 11b generates a diagnostic packet that circulates through an active path of the network relay device based on the diagnostic packet generation table 11g. That is, the diagnostic packet generator 11b generates a diagnostic packet that circulates through an active path based on the information of the routing table 11f storing information of transfer destinations of user packets.

The diagnostic packet transmitter 11c outputs a diagnostic packet generated by the diagnostic packet generator 11b to the SFM 12.

The diagnostic packet receiver 11d receives the diagnostic packet having circulated within the network relay device from the SFM 12.

The determiner 11e determines a failure of the network relay device based on the diagnostic packet received by the diagnostic packet receiver 11d.

In the routing table 11f, information for transferring user packets to target destinations is stored.

In the diagnostic packet generation table 11g, information for generating a diagnostic packet is stored.

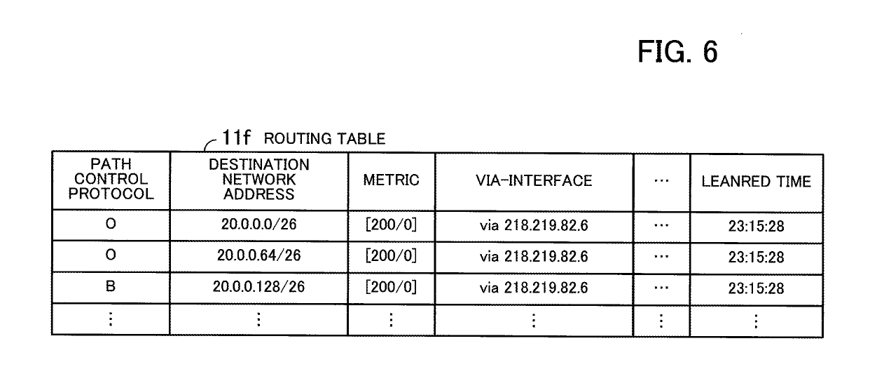

FIG. 6 illustrates the routing table. As illustrated in FIG. 6, the routing table 11f has columns of path control protocol, destination network address, metric, via-interface, and learned time.

In the path control protocol column, information indicating which protocol the SCM 11 has used to learn the routing table 11f is stored. For example, ‘0’ illustrated in FIG. 6 indicates that the routing table 11f is learned by OSPF (Open Shortest Path First). ‘B’ indicates that the routing table 11f is learned by BGP (Border Gateway Protocol).

In the destination network address column, the destination address of a user packet is stored. The right side of the slash after the destination address illustrated in FIG. 6 indicates a subnet mask length.

In the metric column, the distance for a user packet to reach the destination is illustrated.

The via-interface column includes information indicating via which interface a user packet reaches a target destination. For example, the column includes an address of the next router to which the received user packet is transferred.

In the learned time column, the time when the routing table 11f is learned is stored.

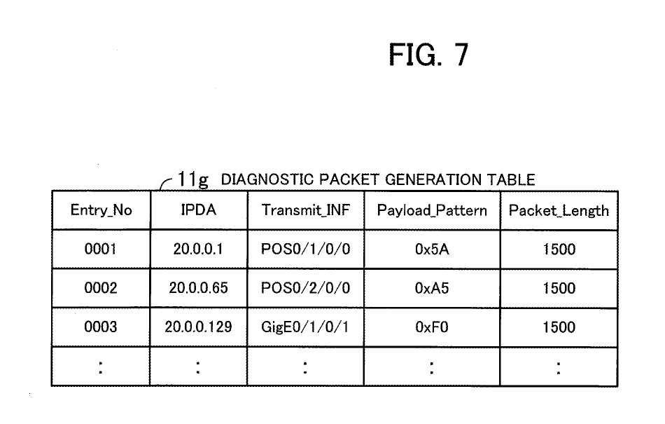

FIG. 7 illustrates the diagnostic packet generation table. As illustrated in FIG. 7, the diagnostic packet generation table 11g has columns of Entry_No, IPDA, Transmit_INF, Payload_Pattern, and Packet_Length.

In the Entry_No column, numbers to identify information to be stored in the diagnostic packet generation table 11g are stored.

In the IPDA column, destination addresses of diagnostic packets are stored.

In the Transmit_INF column, interfaces through which diagnostic packets are sent out are stored. For example, identifiers of ports through which diagnostic packets are sent out are stored.

In the Payload_Pattern column, data patterns to be stored in the payload of diagnostic packets are stored.

In the Packet_Length column, packet lengths of diagnostic packets are stored.

The table generator 11a generates a destination address based on the destination network address of the routing table 11f and stores the destination address in the IPDA column. Due to this, it is possible to set the same destination address as that of the user packet to the diagnostic packet, and therefore, it is made possible to cause the diagnostic packet to circulate through an active path.

Further, the table generator 11a calculates an interface through which a diagnostic packet is sent out so that the diagnostic packet circulates through an active path based on the destination network address and the via-interface of the routing table 11f and stores the interface in Transmit_INF.

Furthermore, the table generator 11a generates a payload pattern having a predetermined ‘0’/‘1’ pattern so as to make it possible to appropriately detect a failure within the network relay device and stores the payload pattern in the Payload_Pattern column.

Still furthermore, the table generator 11a calculates a packet length so as to make it possible to appropriately detect a failure within the network relay device and stores the packet length in the Packet_Length column.

Values of Payload_Pattern and Packet_Length may be fixed values. In this case, the Payload_Pattern and Packet_Length columns are not necessary.

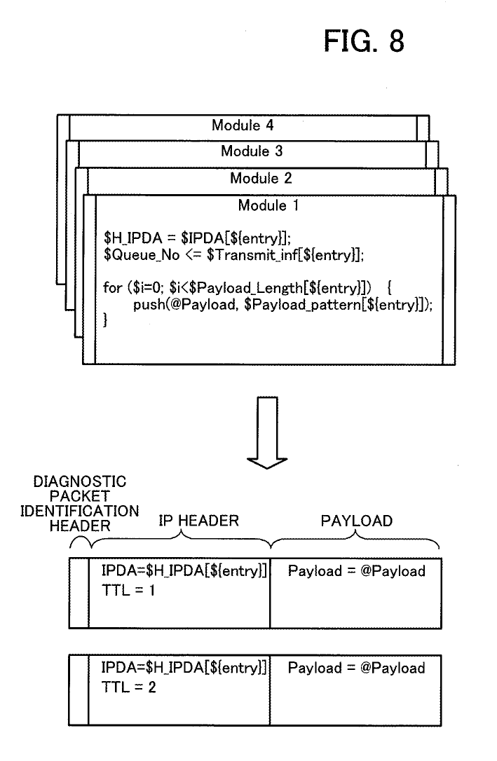

FIG. 8 explains generation of a diagnostic packet. In Module 1 to Module 4 illustrated at the upper side of an arrow in FIG. 8, processing contents of the diagnostic packet generator 11b are illustrated. In Module 1 to Module 4 of FIG. 8, an example of the processing contents is illustrated by the script language Perl and the diagnostic packet generator 11b generates diagnostic packets illustrated at the lower side of the arrow in FIG. 8 by executing the script language of FIG. 8.

For example, the diagnostic packet generator 11b acquires a destination address of IPDA based on Entry_No of the diagnostic packet generation table 11g and stores the destination address in the IP header of the diagnostic packet.

The diagnostic packet generator 11b determines a transmission queue (to be described later) from which the generated diagnostic packet is sent out based on Transmit_INF of the diagnostic packet generation table 11g.

The diagnostic packet generator 11b acquires Payload_Pattern from the diagnostic packet generation table 11g and stores the Payload_Pattern in the payload so that the diagnostic packet has the packet length indicated in Packet_Length.

The diagnostic packet generator 11b stores TTL to enable a diagnosis of an active path of a user packet in the IP header of the diagnostic packet.

The diagnostic packet generator 11b attaches a diagnostic packet identification header indicating that the generated packet is a diagnostic packet.

The diagnostic packet generator 11b generates a diagnostic packet in a plurality of Module 1 to Module 4 in order to, for example, suppress a reduction in the processing performance of a CPU (Central Processing Unit). The diagnostic packet generator 11b generates a diagnostic packet by referring to the diagnostic packet generation table 11g based on different Entry_No in each of Module 1 to Module 4 so as to prevent generation of duplicated diagnostic packets. The number of Module 1 to Module 4 may be one or may be four or more. Further, it may also be possible to realize the processing indicated in Module 1 to Module 4 by dedicated hardware.

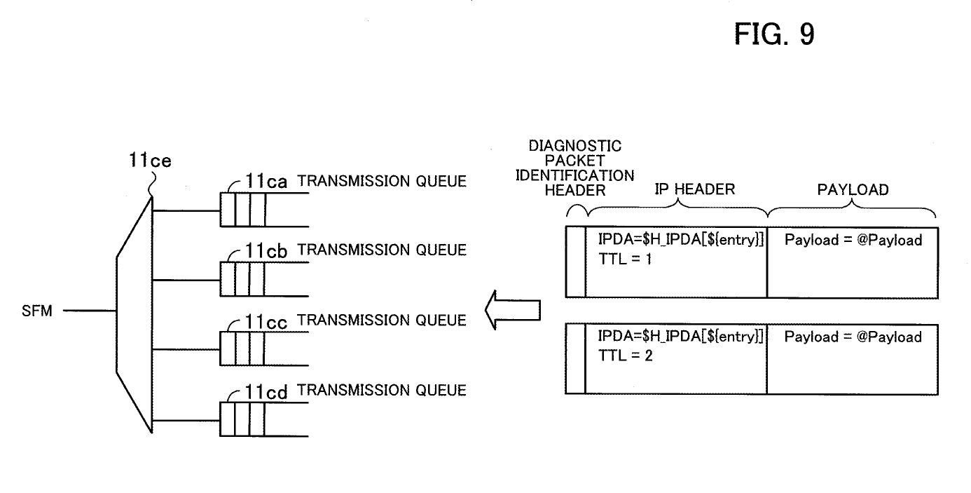

FIG. 9 explains the diagnostic packet transmitter. In FIG. 9, transmission queues 11ca to 11cd and a selector 11ce possessed by the diagnostic packet transmitter 11c are illustrated. In FIG. 9, diagnostic packets generated by the diagnostic packet generator 11b are illustrated.

The transmission queues 11ca to 11cd are provided in correspondence to the PFMs 13a, 13b, 14a, and 14b illustrated in FIG. 3. Due to this, for example, a diagnostic packet input to the transmission queue 11ca is output to the PFM 13a and a diagnostic packet input to the transmission queue 11cb is output to the PFM 13b. In the same manner, a diagnostic packet input to the transmission queue 11cd is output to the PFM 14b.

The selector 11ce outputs the diagnostic packets output from the transmission queues 11ca to 11cd to the SFM 12. Due to this, the diagnostic packets retained in the transmission queues 11ca to 11cd are output to the PFMs 13a, 13b, 14a, and 14b determined in advance via the SFM 12.

Distribution of diagnostic packets to the transmission queues 11ca to 11cd is performed by the diagnostic packet generator 11b. The diagnostic packet generator 11b determines the transmission queues 11ca to 11cd from which the generated diagnostic packets are transmitted based on Transmit_INF of the diagnostic packet generation table 11g and the diagnostic packets are distributed to the transmission queues 11ca to 11cd determined in advance. The diagnostic packets distributed to the transmission queues 11ca to 11cd are output to the PFMs 13a, 13b, 14a, and 14b corresponding to the transmission queues 11ca to 11cd.

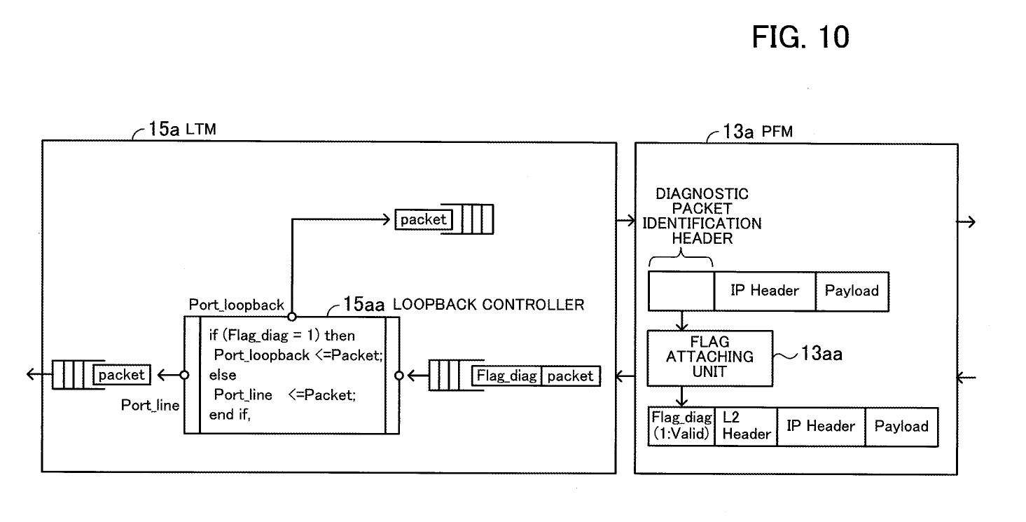

FIG. 10 explains the loopback of a diagnostic packet of the LTM. In FIG. 10, the PFM 13a and LTM 15a illustrated in FIG. 3 are illustrated. As illustrated in FIG. 10, the PFM 13a has a flag attaching unit 13aa and the LTM 15a has a loopback controller 15aa.

In order to cause a diagnostic packet to pass through an active path under an online environment, a user packet is distinguished from a diagnostic packet and the diagnostic packet is caused to loop back within the network relay device. Then, in order to extend the coverage of the diagnosis range within the network relay device, it is effective to loop back the diagnostic packet from a point as close as possible to the opposing network relay device, that is, to loop back on the line side.

However, the processing of a device becomes closer to the processing in the lower layer as the loopback point becomes closer to the line side and, for example, in Layer 2, formats are different for different protocols, such as PPP (Point-to-Point Protocol), Cisco-HDLC (High level Data Link Control procedures), MPLS (Multiprotocol Label Switching), Ethernet (registered trademark), and Ethernet (VLAN-Tag), and therefore, the processing to identify a diagnostic packet becomes complicated.

Because of the above, the diagnostic packet is identified by the PFM 13a, which is the terminating part of Layer 3 and the diagnostic packet is looped back at the LTM 15a that performs Layer 2 processing.

The flag attaching unit 13aa is provided in the E-side module and performs termination processing of Layer 3 of a packet output from the SFM 12. At this time, when detecting the diagnostic packet identification header in the received packet, the flag attaching unit 13aa adds, for example, a flag the value of which is ‘1’ (Flag_diag in FIG. 10) to the head of the diagnostic packet for which termination processing has been performed. The flag attaching unit 13aa outputs the diagnostic packet to which a flag is attached and for which termination processing has been performed to the LTM 15a.

The loopback controller 15aa determines whether or not a flag the value of which is ‘1’ is attached to the head of the packet output from the PFM 13a. When a flag of ‘1’ is attached to the head of the packet output from the PFM 13a, the loopback controller 15aa loops back the packet to within the network relay device. On the other hand, when a flag of ‘1’ is not attached to the head of the packet output from the PFM 13a, the loopback controller 15aa outputs the packet into the opposing network relay device.

For example, when a flag of ‘1’ is attached, the loopback controller 15aa outputs the received packet to Port_loopback illustrated in FIG. 10 and loops back the packet to the PFM 13a. Further, when a flag of ‘1’ is not attached, the loopback controller 15aa outputs the received packet to Port_line illustrated in FIG. 10 and outputs the packet to the opposing network relay device.

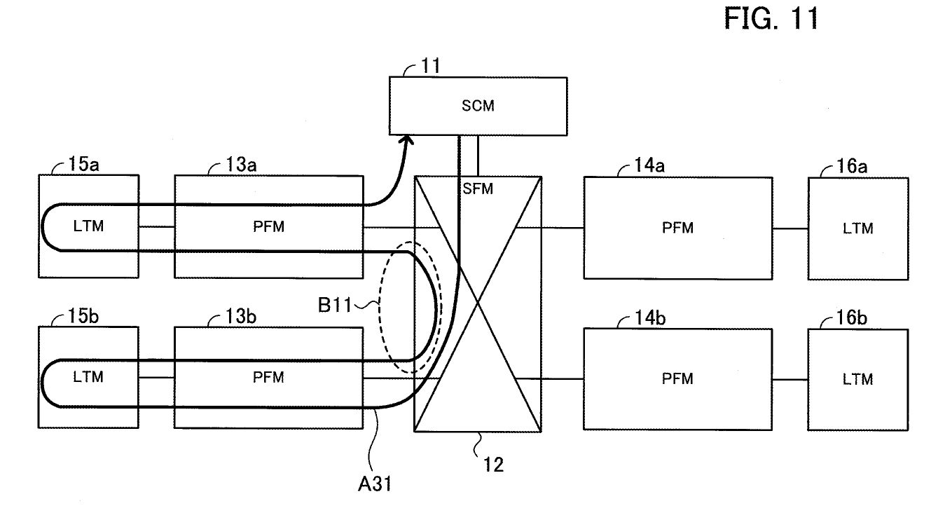

FIG. 11 is a diagram of part 1 for explaining a diagnosis example of an active path. In FIG. 11, the same symbols are attached to the same components as those of FIG. 3 and their explanation is omitted. An arrow A31 indicates a path through which a diagnostic packet passes.

The diagnostic packet generator 11b refers to the diagnostic packet generation table 11g based on Entry_No and acquires IPDA, Transmit_INF, Payload_Pattern, and Packet_Length corresponding to the Entry_No. The diagnostic packet generator 11b generates a diagnostic packet based on the acquired information.

Here, it is assumed that the acquired IPDA indicates, for example, a destination address to which a packet is output to the network relay device in opposition to the LTM 15a. Further, it is assumed that the acquired Transmit_INF indicates the interface (port) of the LTM 15b. Furthermore, it is assumed that the diagnostic packet generator 11b sets ‘2’ to TTL.

In this case, the diagnostic packet generated by the diagnostic packet generator 11b is output to the PFM 13b via the SFM 12.

The PFM 13b performs termination processing of Layer 3 of the diagnostic packet received from the SFM 12 and at the same time, attaches a flag of ‘1’ to the head of the diagnostic packet for which termination processing has been performed and outputs the diagnostic packet to the LTM 15b.

Upon receipt of a packet to the head of which a flag of ‘1’ is attached, the LTM 15b loops back the packet to the PFM 13b.

The PFM 13b extracts a diagnostic packet by performing termination processing of Layer 2 of the looped-back packet and subtracts 1 from TTL. The PFM 13b determines that the transfer destination of the diagnostic packet to be the PFM 13a based on the destination address included in the diagnostic packet and outputs the diagnostic packet to the SFM 12.

The SFM 12 outputs the diagnostic packet output from the PFM 13b to the PFM 13a.

The PFM 13a performs termination processing of Layer 3 of the received diagnostic packet and at the same time, attaches a flag of ‘1’ to the head of the diagnostic packet for which termination processing has been performed and outputs the diagnostic packet to the LTM 15a.

Upon receipt of the packet to the head of which a flag of ‘1’ is attached, the LTM 15a loops back the packet to the PFM 13a.

The PFM 13a performs termination processing of Layer 2 of the looped-back packet and subtracts 1 from TTL. The value of TTL of the diagnostic packet reaches ‘0’ by this subtraction, and therefore, the PFM 13a sends back the diagnostic packet to the SCM 11.

Due to this, it is possible to diagnose an active path via the PFM 13b and the PFM 13a as indicated by a dotted line circle B11 in FIG. 11.

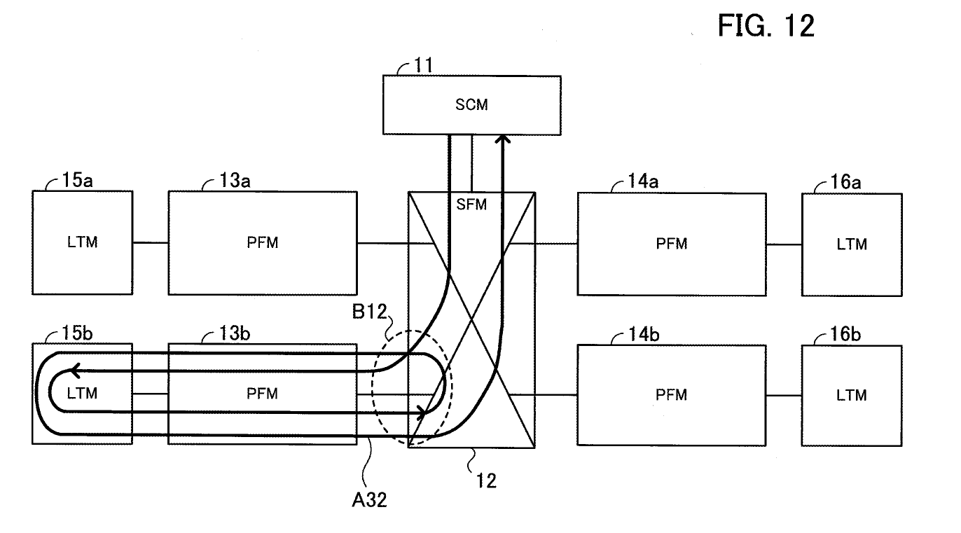

FIG. 12 is a diagram of part 2 for explaining the diagnosis example of an active path. In FIG. 12, the same symbols are attached to the same components as those of FIG. 3 and their explanation is omitted. An arrow A32 indicates a path through which a diagnostic packet passes.

The diagnostic packet generator 11b refers to the diagnostic packet generation table 11g based on Entry_No and acquires IPDA, Transmit_INF, Payload_Pattern, and Packet_Length corresponding to the Entry_No. The diagnostic packet generator 11b generates a diagnostic packet based on the acquired information.

Here, it is assumed that the acquired IPDA indicates, for example, a destination address to which a packet is output to the network relay device in opposition to the LTM 15b. Further, it is assumed that the acquired Transmit_INF indicates the interface of the LTM 15b. Furthermore, it is assumed that the diagnostic packet generator sets 11b ‘2’ to TTL.

In this case, the diagnostic packet generated by the diagnostic packet generator 11b is output to the PFM 13b via the SFM 12.

The PFM 13b performs termination processing of Layer 3 of the diagnostic packet received from the SFM 12 and at the same time, attaches a flag of ‘1’ to the head of the diagnostic packet for which termination processing has been performed and outputs the diagnostic packet to the LTM 15b.

Upon receipt of the packet to the head of which a flag of ‘1’ is attached, the LTM 15b loops back the packet to the PFM 13b.

The PFM 13b extracts the diagnostic packet by performing termination processing of Layer 2 of the looped-back packet and subtracts 1 from TTL. The PFM 13b determines that the transfer destination of the diagnostic packet is the PFM 13b based on the destination address included in the diagnostic packet and outputs the diagnostic packet to the SFM 12.

The SFM 12 outputs the diagnostic packet output from the PFM 13b to the PFM 13b.

The PFM 13b performs termination processing of Layer 3 of the received diagnostic packet and at the same time, attaches a flag of ‘1’ to the head of the diagnostic packet for which termination processing has been performed and outputs the diagnostic packet to the LTM 15b.

Upon receipt of the packet to the head of which a flag of ‘1’ is attached, the LTM 15b loops back the packet to the PFM 13b.

The PFM 13b performs termination processing of Layer 2 of the looped-back packet and subtracts 1 from TTL. The value of TTL of the diagnostic packet reaches ‘0’ by this subtraction, and therefore, the PFM 13b sends back the diagnostic packet to the SCM 11.

Due to this, it is possible to diagnose an active path that loops back through the PFM 13b itself as indicated by a dotted line circle B12 in FIG. 12.

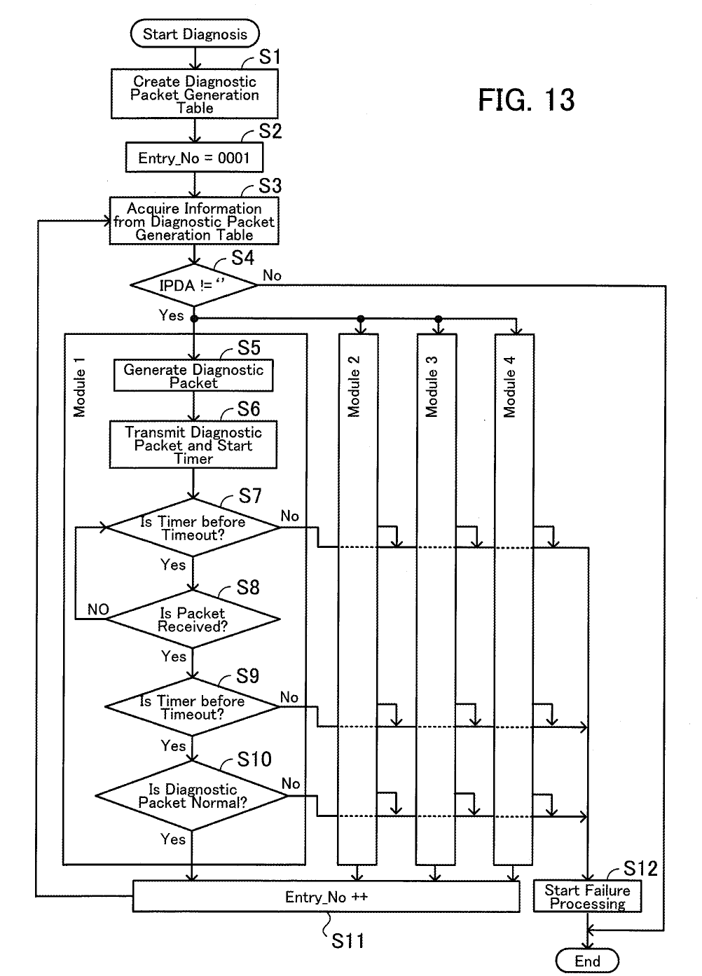

FIG. 13 is a flowchart illustrating diagnosis processing of an active path.

(Step S1) The table generator 11a generates the diagnostic packet generation table 11g based on the routing table 11f. The routing table 11f changes dynamically. Because of that, the table generator 11a generates the diagnostic packet generation table 11g when, for example, diagnosing an active path of the network relay device so that the diagnostic packet generation table 11g in synchronization with the change is generated.

(Step S2) The diagnostic packet generator 11b sets ‘0001’ to the variable Entry_No.

(Step S3) The diagnostic packet generator 11b refers to Entry_No of the diagnostic packet generation table 11g based on the variable Entry_No ‘0001’ and acquires information of IPDA, Transmit_INF, Payload_Pattern, and Packet_Length.

It is assumed that the network relay device has four Module 1 to Module 4 configured to generate diagnostic packets. Consequently, the diagnostic packet generator 11b refers to Entry_No of the diagnostic packet generation table 11g corresponding to the variable Entry_Nos ‘0001’ to ‘0004’ and acquires information of IPDA, Transmit_INF, Payload_Pattern, and Packet_Length. Module 1 to Module 4 of FIG. 13 correspond to Module 1 to Module 4 of FIG. 8.

(Step S4) The diagnostic packet generator 11b determines whether there is no information in the IPDA column of the diagnostic packet generation table 11g. When there is information in the IPDA column, the diagnostic packet generator 11b proceeds to step S5. When there is no information in the IPDA column, the diagnostic packet generator 11b exits the processing.

(Step S5) The diagnostic packet generator 11b generates a diagnostic packet based on the acquired information. The diagnostic packet generator 11b sets TTL so that the PFMs 13a, 13b, 14a, and 14b return the diagnostic packet to the SCM 11 when the generated diagnostic packet circulates through a predetermined active path. Further, the diagnostic packet generator 11b determines the transmission queues 11ca to 11cd from which the generated diagnostic packets are sent out, that is, the PFMs 13a, 13b, 14a, and 14b, based on Transmit_INF acquired from the diagnostic packet generation table 11g.

In the following, the operation of Module 1 is explained. In Module 2 to Module 4 also, a diagnostic packet is generated and an active path is diagnosed based on the information in which Entry_No of Module 1 is incremented one by one, respectively.

(Step S6) The diagnostic packet transmitter 11c outputs the generated diagnostic packets to the PFMs 13a, 13b, 14a, and 14b determined in advance via the SFM 12. A timer unit, not illustrated in FIG. 5, starts a timer when the diagnostic packet transmitter 11c outputs a diagnostic packet to the SFM 12.

(Step S7) The determiner 11e determines whether or not the timer is before the timeout. When the timer is before the timeout, the determiner 11e proceeds to step S8. When the timer has reached the timeout, the determiner 11e proceeds to step S12.

(Step S8) The diagnostic packet receiver 11d determines whether or not a diagnostic packet having circulated through an active path is received. When the diagnostic packet is received, the diagnostic packet receiver 11d proceeds to step S9. When the diagnostic packet is not received, the diagnostic packet receiver 11d proceeds to step S7.

(Step S9) The determiner 11e determines whether or not the timer is before the timeout. When the timer is before the timeout, the determiner 11e proceeds to step S10. When the timer has reached the timeout, the determiner 11e proceeds to step S12.

(Step S10) The determiner 11e determines whether or not the diagnostic packet received by the diagnostic packet receiver 11d is normal. For example, the determiner 11e determines that the received diagnostic packet is normal when the payload of the received diagnostic packet is the same as that before the transmission. When the diagnostic packet is normal, the determiner 11e proceeds to step S11. When the diagnostic packet is not normal, the determiner 11e proceeds to step S12.

(Step S11) The diagnostic packet generator 11b increments the variable Entry_No. In the case of FIG. 13, there exist four modules configured to generate diagnostic packets, and therefore, the diagnostic packet generator 11b increments the variable Entry_No by ‘4’. Consequently, for example, when the diagnostic packet generator 11b generates diagnostic packets by referring to the diagnostic packet generation table 11g based on Entry_Nos ‘0001’ to ‘0004’ in Module 1 to Module 4, the next time, the diagnostic packet generator 11b will generate diagnostic packets by referring to the diagnostic packet generation table 11g based on Entry_Nos ‘0001’ to ‘0004’ as a result.

(Step S12) The determiner 11e starts failure processing. For example, the determiner 11e notifies an operator that a failure has occurred in an active path within the device.

As described above, the network relay device generates the diagnostic packet generation table 11g for generating a diagnostic packet that circulates through an active path within the device based on the routing table 11f. Then, the network relay device generates a diagnostic packet based on the diagnostic packet generation table 11g and causes the diagnostic packet to circulate through an active path within the device. Due to this, it is possible to diagnose the path through which a user packet passes.

Further, for example, it is possible to diagnose data within a memory for determining a path of a user packet of the PFMs 13a, 13b, 14a, and 14b and to diagnose a software error. More specifically, it is made possible to detect: 1) a software error and bit stuck as to an active region in a shared memory within the PFM; 2) a software error and bit stuck as to active address management FIFO; 3) an anomalous operation of a scheduler logic unit as to an active flow; 4) an anomalous operation of a queuing controller logic unit as to an active flow; and 5) a software error and bit stuck of an active CAM (Content Addressable Memory).

Furthermore, it is possible to diagnose an active path of the SFM 12. More specifically, it is made possible to detect: 1) BP (Back Pressure) stuck of the SFM 12; 2) a software error and bit stuck of the SFM 12; and 3) anomalous switching logic of the SFM 12.

Next, a third embodiment is explained in detail with reference to the drawings. The network relay device generates a diagnostic packet and causes the diagnostic packet to circulate within the device in order to diagnose its active path. Because of that, there is a possibility that the signal band within the device is strained. Consequently, in the third embodiment, a diagnostic packet having a payload the size of which is different is generated in accordance with the load of the network relay device to reduce the load by the diagnostic packet of the network relay device. The block diagram of the SCM in the third embodiment is the same as the SCM 11 of FIG. 5.

The diagnostic packet generator 11b generates a first diagnostic packet and a second diagnostic packet of different IP lengths. The first diagnostic packet is assumed to have the smallest sized IP length. That is, the first diagnostic packet is assumed to have only the IP header (20 bytes) used for routing processing.

On the other hand, the second diagnostic packet is assumed to have an IP length longer than that of the first diagnostic packet, for example, an IP length of 1,500 bytes. The reason is that the first diagnostic packet having the smallest size has no payload, and therefore, it is not possible to inspect alteration etc. of payload data that is caused by path switching etc., and for example, it is not possible to diagnose all the contents of the memory possessed by the PFM, LTM, and SFM.

As explained in FIG. 5, the diagnostic packet generator 11b generates the first diagnostic packet and the second diagnostic packet based on the diagnostic packet generation table 11g. However, in Packet_Length of the diagnostic packet generation table 11g, for example, ‘0’ and ‘1,500’ are stored in a predetermined ratio. That is, the table generator 11a generates the diagnostic packet generation table 11g so that the first diagnostic packet and the second diagnostic packet are generated in a predetermined ratio by the diagnostic packet generator 11b.

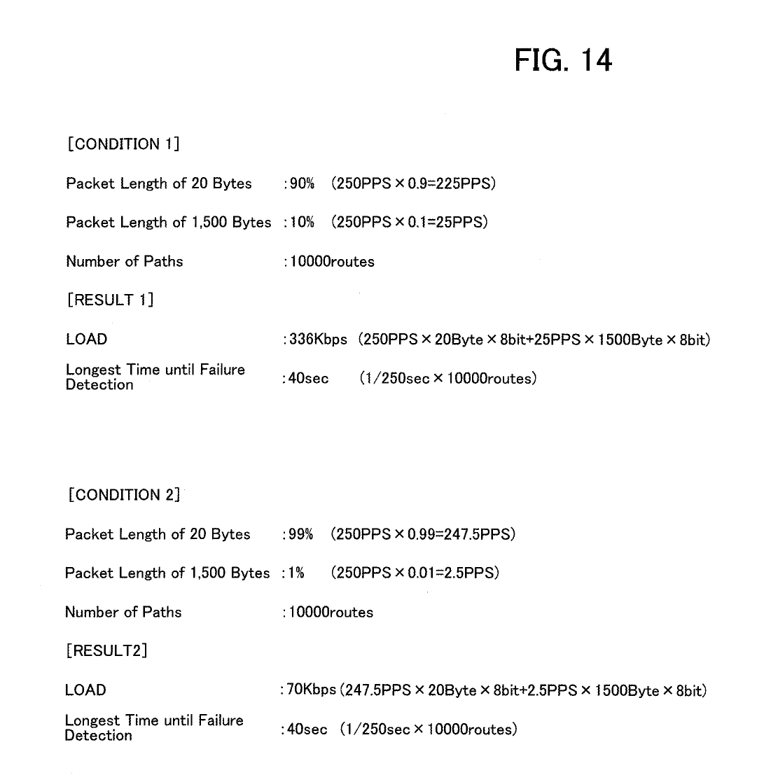

FIG. 14 explains the load of the network relay device by the diagnostic packet. In the following, it is assumed that the diagnostic packet generator 11b generates the first diagnostic packet and the second diagnostic packet at 250 PPS (Packet Per Second). FIG. 14 illustrates a result 1 under a condition 1 and a result 2 under a condition 2.

The condition 1 is a case where the first diagnostic packet and the second diagnostic packet are generated in a ratio of 90%:10% and the number of packet paths is assumed to be 10,000. In this case, as illustrated in the result 1, the load by the diagnostic packet of the network relay device is 336 Kbps and the longest time until the detection of a failure is 40 sec.

The condition 2 is a case where the first diagnostic packet and the second diagnostic packet are generated in a ratio of 99%:1% and the number of packet paths is assumed to be 10,000. In this case, as illustrated in the result 2, the load by the diagnostic packet of the network relay device is 70 Kbps and the longest time until the detection of a failure is 40 sec.

In this manner, it is possible to reduce the load by the diagnostic packet of the network relay device and to suppress a reduction in the signal band by increasing the ratio of the first diagnostic packet having a short IP length. On the other hand, when there is a margin in the signal band, by increasing the ratio of the second diagnostic packet, it is made possible to appropriately diagnose the memory contents possessed by, for example, the PFM, LTM, and SFM. Further, it is made possible to detect a failure at the same level as that of the failure detection of OSPF (Hold Timer: 40 sec).

In the above, the case where there exists a payload and the case where there exists no payload are explained, but, the case is not limited to those. For example, it may also be possible to generate the first diagnostic packet and the second diagnostic packet having, for example, a payload of 50 bytes and a payload of 1,000 bytes, respectively. That is, it is possible to generate the first diagnostic packet and the second diagnostic packet having a packet length different from that of the first diagnostic packet in accordance with the signal band.

In the above, the two kinds of diagnostic packet are explained, but, it may also be possible to generate three or more kinds of diagnostic packet having different IP lengths and to control the ratio between them in accordance with the load of the network relay device.

Next, a fourth embodiment is explained in detail with reference to the drawings. In the fourth embodiment, a method for identifying a failed portion of the network relay device is explained. In the fourth embodiment, the diagnostic packet is caused to circulate within the repeater through paths of a plurality of patterns and a failed portion is specified based on the passing-through result of the diagnostic packet in each pattern.

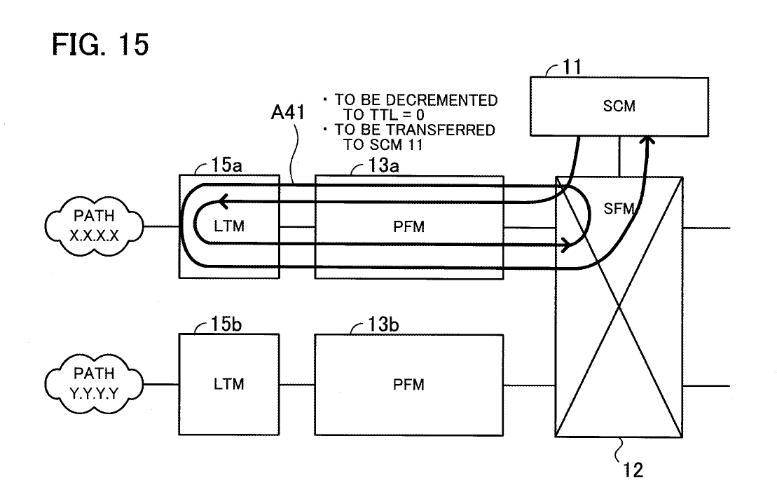

FIG. 15 is a diagram of part 1 for explaining a diagnostic path for identifying a failed portion of the network relay device. In FIG. 15, the same symbols are attached to the same components as those of FIG. 3 and their explanation is omitted. In FIG. 15, part of FIG. 3 is omitted. It is assumed that to the LTM 15a, a network of a path X.X.X.X is connected and to the LTM 15b, a network of a path Y.Y.Y.Y is connected.

The diagnostic packet generator 11b generates a diagnostic packet based on the diagnostic packet generation table 11g so that the diagnostic packet is output to the path X.X.X.X through the shortest path. Further, the diagnostic packet generator 11b sets TTL=2 so that the diagnostic packet loops back through the PFM 13a itself. Due to this, the diagnostic packet passes through a path indicated by an arrow A41 of FIG. 15.

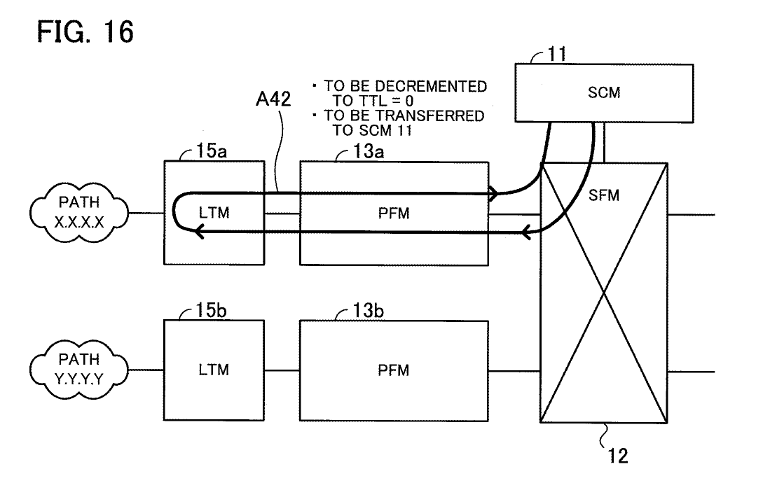

FIG. 16 is a diagram of part 2 for explaining the diagnostic path for identifying a failed portion of the network relay device. In FIG. 16, the same symbols are attached to the same components as those of FIG. 15 and their explanation is omitted.

The diagnostic packet generator 11b generates a diagnostic packet based on the diagnostic packet generation table 11g so that the diagnostic packet is output to the path X.X.X.X through the shortest path. Further, the diagnostic packet generator 11b sets TTL=1 so that the diagnostic packet returns through the shortest path. Due to this, the diagnostic packet passes through a path indicated by an arrow A42 of FIG. 16.

Here, in the diagnosis of the path explained in FIG. 15, when the diagnostic packet does not return to the SCM 11, the determiner 11e estimates that a failure has occurred between the PFM 13a and LTM 15a, in the SFM 12 that connects the PFM 13a and the PFM 13a, or between the SCM 11 and SFM 12. Further, the determiner 11e estimates that a failure has also occurred in the setting of the loopback path determined in the PFM 13a (determination of the path of the PFM 13a).

Then, the diagnostic packet generator 11b generates and sends out a diagnostic packet of TTL=1 illustrated in FIG. 16. When the diagnostic packet of TTL=1 has returned to the SCM 11, the determiner 11e identifies a failed portion by determining that a failure exists in the determination of the path of the PFM 13a or in the SFM 12 that connects the PFM 13a and the PFM 13a.

On the other hand, when the diagnostic packet of TTL=1 does not return to the SCM 11, the determiner 11e limits a failed range by determining that a failure exists between the PFM 13a and the LTM 15a or between the SCM 11 and the SFM 12.

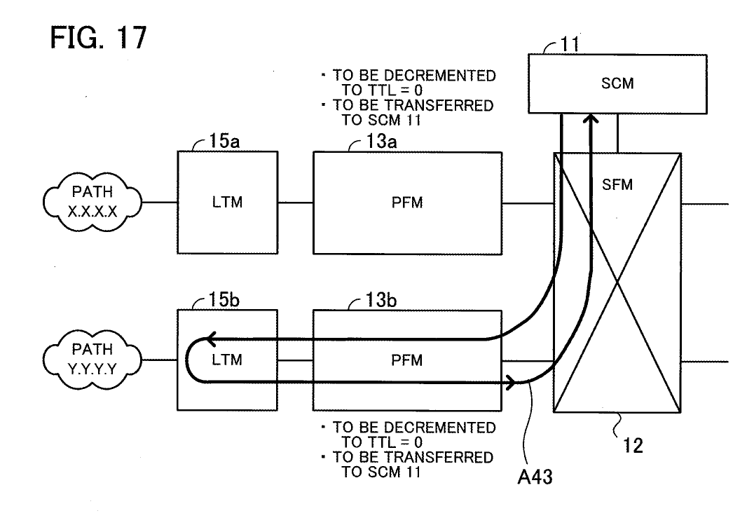

FIG. 17 is a diagram of part 3 for explaining the diagnostic path for identifying a failed portion of the network relay device. In FIG. 17, the same symbols are attached to the same components as those of FIG. 15 and their explanation is omitted.

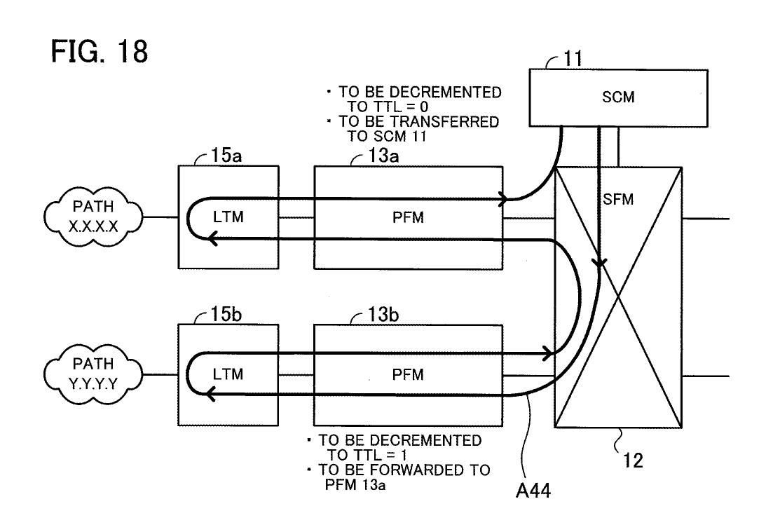

The diagnostic packet generator 11b generates a diagnostic packet based on the diagnostic packet generation table 11g so that the diagnostic packet is sent out to the PFM 13b and the LTM 15b different from the PFM 13a and the LTM 15a. For example, the diagnostic packet generator 11b generates a diagnostic packet of TTL=1 to be sent out to the path Y.Y.Y.Y. Due to this, the diagnostic packet passes through a path indicated by an arrow A43 of FIG. 18.

When the diagnostic packet does not return in the diagnosis of the path explained in FIG. 15 and FIG. 16 but the diagnostic packet has returned to the SCM 11 in the diagnosis of the path of FIG. 17, the determiner 11e identifies a failed portion by determining that a failure exists between the PFM 13a and the LTM 15a.

On the other hand, when the diagnostic packet does not return to the SCM 11 in the diagnosis of the path of FIG. 17, the determiner 11e identifies a failed portion by determining that a failure exits between the SCM 11 and the SFM 12.

FIG. 18 is a diagram of part 4 for explaining the diagnostic path for identifying a failed portion of the network relay device. In FIG. 18, the same symbols are attached to the same components as those of FIG. 15 and their explanation is omitted.

The diagnostic packet generator 11b generates a diagnostic packet based on the diagnostic packet generation table 11g so that the diagnostic packet is output to the path X.X.X.X via between the PFMs. For example, as illustrated in FIG. 18, the diagnostic packet generator 11b generates a diagnostic packet to be output to the LTM 15b so that the diagnostic packet is output to the path X.X.X.X via between the PFMs 13b and 13a. Further, the diagnostic packet generator 11b sets TTL=2 so that the diagnostic packet returns to the SCM 11 via between the PFMs 13b and 13a. Due to this, the diagnostic packet passes through a path indicated by an arrow A44 of FIG. 18.

When the diagnostic packet has returned in the diagnosis of the path explained in FIG. 15, it is possible for the determiner 11e to determine that no failure exists between the PFM 13a and the LTM 15a, in the determination of the path of PFM 13a through which the user packet is looped back, in the SFM 12 that connects the PFM 13a and the PFM 13a, or between the SCM 11 and the SFM 12. Then, when the diagnostic packet has returned to the SCM 11 in the diagnosis of the path of FIG. 18, it is possible for the determiner 11e to further determine that no failure exists in the SFM 12 that connects the PFM 13b and the PFM 13a.

On the other hand, when the diagnostic packet does not return to the SCM 11 in the diagnosis of the path of FIG. 18, the determiner 11e limits a failed portion by determining that a failure exists between the PFM 13b and the LTM 15b, in the path determination of the PFM 13b through which the user packet is transferred to the PFM 13a, or in the SFM 12 that connects the PFM 13b and the PFM 13a. In this case, when the diagnosis of the path of FIG. 17 is performed and if the diagnostic packet returns, the determiner 11e identifies a failed portion by determining that a failure exists in the path determination of the PFM 13b or in the SFM 12 that connects the PFM 13b and the PFM 13a.

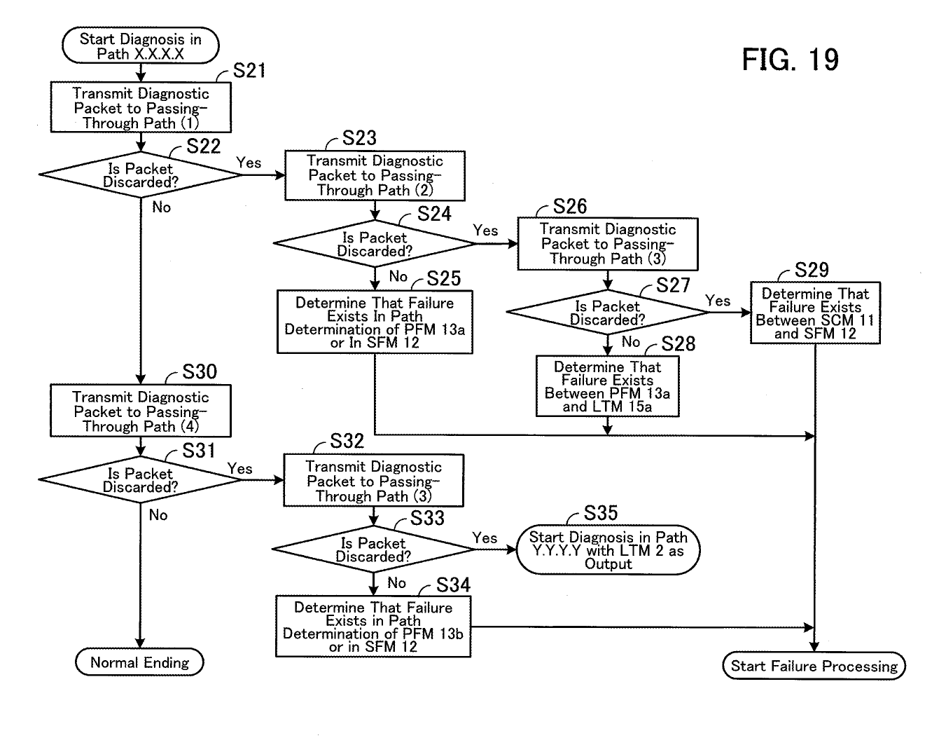

FIG. 19 is a flowchart illustrating processing to identify a failed portion. A passing-through path (1) illustrated in FIG. 19 indicates the path of the diagnostic packet indicated by the arrow A41 of FIG. 15. A passing-through path (2) indicates the path of the diagnostic packet indicated by the arrow A42 of FIG. 16. A passing-through path (3) indicates the path of the diagnostic packet indicated by the arrow A43 of FIG. 17. A passing-through path (4) indicates the path of the diagnostic packet indicated by the arrow A44 of FIG. 18.

(Step S21) The diagnostic packet generator 11b generates a diagnostic packet that passes via the passing-through path (1). The diagnostic packet transmitter 11c outputs the generated diagnostic packet to the PFM 13a via the SFM 12.

(Step S22) The determiner 11e determines whether or not the diagnostic packet is discarded. That is, the determiner 11e determines whether or not the diagnostic packet is received by the diagnostic packet receiver 11d. When the determiner 11e determines that the diagnostic packet is discarded, the procedure proceeds to step S23. When the determiner 11e determines that the diagnostic packet is not discarded, the procedure proceeds to step S30.

(Step S23) The diagnostic packet generator 11b generates a diagnostic packet that passes via the passing-through path (2). The diagnostic packet transmitter 11c outputs the generated diagnostic packet to the PFM 13a via the SFM 12.

(Step S24) The determiner 11e determines whether or not the diagnostic packet is discarded. When the determiner 11e determines that the diagnostic packet is discarded, the procedure proceeds to step S26. When the determiner 11e determines that the diagnostic packet is not discarded, the procedure proceeds to step S25.

(Step S25) The determiner 11e determines that a failure exists in the path determination of the PFM 13a to which the diagnostic packet is looped back or in the SFM 12 that connects the PFM 13a and the PFM 13a. When determining a failure, the determiner 11e starts failure processing and for example, transfers a packet through another path within the device.

(Step S26) The diagnostic packet generator 11b generates a diagnostic packet that passes via the passing-through path (3). The diagnostic packet transmitter 11c outputs the generated diagnostic packet to the PFM 13b via the SFM 12.

(Step S27) The determiner 11e determines whether or not the diagnostic packet is discarded. When the determiner 11e determines that the diagnostic packet is discarded, the procedure proceeds to step S29. When the determiner 11e determines that the diagnostic packet is not discarded, the procedure proceeds to step S28.

(Step S28) The determiner 11e determines that a failure exits between the PFM 13a and the LTM 15a. When determining a failure, the determiner 11e starts failure processing and, for example, transfers a packet through another path within the device.

(Step S29) The determiner 11e determines that a failure exists between the SCM 11 and the SFM 12. When determining a failure, the determiner 11e starts failure processing and, for example, transfers a packet through another path within the device.

(Step S30) The diagnostic packet generator 11b generates a diagnostic packet that passes via the passing-through path (4). The diagnostic packet transmitter 11c outputs the generated diagnostic packet to the PFM 13b via the SFM 12.

(Step S31) The determiner 11e determines whether or not the diagnostic packet is discarded. When the determiner 11e determines that the diagnostic packet is discarded, the procedure proceeds to step S32. When determining that the diagnostic packet is not discarded, the determiner 11e determines that the path of the packet to be output to the path X.X.X.X is not anomalous and exits the processing.

(Step S32) The diagnostic packet generator 11b generates a diagnostic packet that passes via the passing-through path (3). The diagnostic packet transmitter 11c outputs the generated diagnostic packet to the PFM 13b via the SFM 12.

(Step S33) The determiner 11e determines whether or not the diagnostic packet is discarded. When the determiner 11e determines that the diagnostic packet is discarded, the procedure proceeds to step S35. When the determiner 11e determines that the diagnostic packet is not discarded, the procedure proceeds to step S34.

(Step S34) The determiner 11e determines that a failure exists in the path determination of the PFM 13b through which the user packet is transferred to the PFM 13a or in the SFM 12 that connects the PFM 13b and the PFM 13a. When determining a failure, the determiner 11e starts failure processing and for example, transfers a packet through another path within the device.

(Step S35) The determiner 11e limits a failed portion by determining that a failure exits between the PFM 13b and the LTM 15b or in the SFM 12 that connects the PFM 13b and the PFM 13b and starts a diagnosis in the path Y.Y.Y.Y. That is, the SCM 11 identifies a failed portion in the path Y.Y.Y.Y by performing the same path diagnosis as that in the path X.X.X.X.

As described above, the SCM 11, generates a plurality of diagnostic packets of different values of TTL to be output to the path X.X.X.X, for example, as explained in FIG. 15 and FIG. 16. Further, the SCM 11 generates a diagnostic packet that passes via the path through which the packet is output to another path Y.Y.Y.Y, for example, as explained in FIG. 17. Furthermore, the SCM 11 generates a diagnostic packet that passes via the path running across the PFMs 13a and 13b and which is output to the path X.X.X.X, for example, as explained in FIG. 18. Due to this, it is possible for the SCM 11 to identify a failed portion within the device in the path X.X.X.X.

According to the network relay device and the diagnostic method disclosed herein, it is possible to diagnose a path through which a user packet passes.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A network relay device that diagnoses a path of a packet within the device, comprising:
a routing table configured to store information of a transfer destination of the packet;
a forwarding unit configured to determine a transfer destination of the packet based on the information of the routing table;
a switch unit configured to switch output destinations of the packet to the forwarding unit based on the determination of a transfer destination by the forwarding unit;
a diagnostic packet generator configured to generate a diagnostic packet that circulates through an active path within the device based on the information of the routing table; and
a diagnostic packet transmitter configured to send out the diagnostic packet generated by the diagnostic packet generator to the forwarding unit via the switch unit.

2. The network relay device according to claim 1,
wherein upon receipt of the diagnostic packet from the switch unit, the forwarding unit attaches a flag to the diagnostic packet and outputs the diagnostic packet to a layer processor configured to perform layer processing lower than the layer processing of the forwarding unit.

3. The network relay device according to claim 2,
wherein upon receipt of the diagnostic packet to which a flag is attached from the forwarding unit, the layer processor loops back the diagnostic packet to the forwarding unit.

4. The network relay device according to claim 1,
wherein the diagnostic packet generator generates the diagnostic packets of different survival times.

5. The network relay device according to claim 1,
wherein the diagnostic packet generator generates the diagnostic packet going from the forwarding unit to another forwarding unit via the switch unit.

6. The network relay device according to claim 1,
wherein the diagnostic packet generator generates the diagnostic packets of different payload lengths in a predetermined ratio.

7. The network relay device according to claim 1,
wherein the diagnostic packet generator generates a plurality of the diagnostic packets that circulate through a path within the device, and
wherein the network relay device further comprises a determiner configured to identify a failed portion of a path within the device based on whether or not the determiner has received the plurality of the diagnostic packets generated by the diagnostic packet generator.

8. The network relay device according to claim 3, further comprising a table generator configured to generate a diagnostic packet generation table for generating the diagnostic packet that circulates through an active path within the device based on the routing table,
wherein the diagnostic packet generator generates the diagnostic packet based on the diagnostic packet generation table.

9. A diagnostic method of a network relay device that diagnoses a path of a packet within the device, the device including:
a routing table configured to store information of a transfer destination of the packet;
a forwarding unit configured to determine the transfer destination of the packet based on the information of the routing table; and
a switch unit configured to switch output destinations of the packet to the forwarding unit based on the determination of the transfer destination by the forwarding unit, the method comprising:
generating a diagnostic packet that circulates through an active path within the device based on the information of the routing table; and
sending out the generated diagnostic packet to the forwarding unit via the switch unit.
